(19) United States
(12) Patent Application Publication
(10) Pub. No.: US 2025/0123026 A1
(43) Pub. Date: Apr. 17, 2025

(54) Air Conditioning System and Method of Manufacturing an Air Conditioning System

(71) Applicant: Truma Gerätetechnik GmbH & Co. KG, Putzbrunn (DE)

(72) Inventor: Matthäus Moser, Putzbrunn (DE)

(21) Appl. No.: 18/728,804

(22) PCT Filed: Jul. 25, 2022
(86) PCT No.: PCT/EP2022/000064

§ 371 Date: Jul. 12, 2024

(30) Foreign Application Priority Data
Jan. 18, 2022 (DE) 102022000174.8

(51) Int. Cl. F24F 13/30

(52) U.S. Cl. CPC F24F 13/30

(57) ABSTRACT

The invention relates to an air conditioning system. A holding device (10) fixes a heat exchanger (6) in a housing (1). A clamping member (13) is arranged in a recess (12) of a base body (11) such that the base body (11) and/or the clamping member (13) are/is in sealing contact with the heat exchanger (6). The invention furthermore relates to a method of manufacturing an air conditioning system.

### TECHNICAL FIELD

The present invention relates to an air conditioning system. For example, it relates to an air conditioning system to be fixed on the roof of a vehicle (a mobile home or a caravan, for example). The invention furthermore relates to a method of manufacturing an air conditioning system.

### BACKGROUND

The principle of refrigeration by means of a cooling circuit on which air cooling is based is described, for example, in WO 2007/042065 A1. In most cases, two fans and two heat exchangers are provided in such air conditioning systems: one fan and an associated heat exchanger belong to the evaporator in which the air of the room to be cooled is cooled by the interaction with the refrigerant. A further fan and an associated heat exchanger belong to the condenser in which thermal energy of the refrigerant is transferred to the ambient air and is thus dissipated.

Finned tube heat exchangers—as described in WO 2017/108289 A1, for example—are composed of fins which are connected to tubes. The tubes carry the refrigerant. End plates by means of which the heat exchanger is fixed in the housing are mounted at the end of the tubes. Elbows connecting the tubes to each other for the refrigerant are located on an outer side of the end plates. The heat exchanger thus has an inner area between the end plates and two front sides beyond the end plates. According to WO 2007/042065 A1, the heat exchangers are for example fixed in the EPP housing via the end plates thereof.

If inflammable refrigerants are used, the air conditioning system is usually subdivided into two areas which are assigned to the interior (the so-called indoor area) and to the environment (the so-called outdoor area). The air of the interior space is cooled by the air conditioning system. The two areas are separated from each other and it is ensured that any leaking refrigerant does not enter the area which is assigned to the interior. A sealing therefore has to be created in the heat exchangers between the interior space and the front sides beyond the end plates which in particular have the elbows. For sealing, the end plates usually have bent longitudinal sides which permit a larger sealing surface. Typically, the manufacturing and production tolerances are problematic in sealings.

Document WO 2019/115730 A1 for example describes a ventilation apparatus in which a heat exchanger is fastened by a wedging unit.

### SUMMARY

The object on which the invention is based is to provide an air conditioning system having a sealing which is as reliable as possible between the inner area and the front sides of a heat exchanger.

The object is achieved by the invention by an air conditioning system comprising a housing, at least one heat exchanger and a holding device, wherein the holding device fixes the heat exchanger in the housing, wherein the holding device has a base body having at least one recess and at least one clamping member, and wherein the holding device and the heat exchanger are configured and arranged relative to each other such that the base body and/or the clamping member are/is—indirectly or directly—in sealing contact with the heat exchanger.

In the air conditioning system according to the invention, a sealing connection is generated between the heat exchanger and a base body of the holding device and/or a clamping member inserted into the base body. Therefore, depending on the configuration, the base body and/or the clamping member are/is in direct contact with the heat exchanger, or another component, for example also a sealing component, is located between the heat exchanger and the base body or the clamping member.

In one embodiment, the recess is configured as a bore. In an alternative or additional embodiment, the clamping member is configured as a pin.

The way in which the sealing contact of the base body or the clamping member with the heat exchanger is provided or achieved is the subject matter of the embodiments below.

One embodiment of the air conditioning system provides that the clamping member has an oversize relative to the recess such that the base body—due to the inserted clamping member—is deformed, and that the deformed base body is in sealing contact with the heat exchanger. In this embodiment, the clamping member has a greater extension than the recess in at least one direction. Due to the oversize, the base body deforms and is in sealing contact with the heat exchanger. To this end, the materials of the base body (at least around the recess) and of the clamping member are adapted to each other such that the oversize deforms the base body more strongly than the clamping member.

One alternative or additional embodiment provides that in a relative orientation between the clamping member and the recess, the base body is deformed such that the deformed base body is in sealing contact with the heat exchanger. In other words, this embodiment provides that the clamping member is oriented in the recess such that the base body is deformed, and that the deformed base body is in sealing contact with the heat exchanger. In this embodiment, the base body is subjected to a deformation due to the relative orientation between the clamping member and the recess. Preferably, there is an alternative orientation of the clamping member in the recess in which no or only such a small deformation occurs that the base body is not in contact with the heat exchanger. The embodiment makes it easier to remove the heat exchanger from the air conditioning system in case of servicing and then to regenerate a constant sealing effect. The clamping member has to be moved accordingly between the two orientations. Preferably, there is only one orientation in which the base body is in sealing contact with the heat exchanger.

In one embodiment, the clamping member is rotated about a longitudinal axis between the orientations relative to the recess to achieve the deformation.

In one embodiment, either the recess or the clamping member has an asymmetrical inner or outer contour. For example, the recess and the clamping member have an oval basic shape with the same surface area, the recess and the clamping member each having a cylindrical shape. In one rotary position, the recess and the clamping member have an exact fit, so that no material displacement occurs. In case of a rotation about 90°, for example, about a longitudinal axis of the recess and the clamping member—for a change in orientation—(and thus in case of a second rotary position generated by the rotation), the material of the base body is moved or displaced to the outside and thus in the direction of the heat exchanger.

In one embodiment, the recess and the distance from the area via which the base body is in contact with the heat exchanger, are designed and adapted to each other such that the part of the base body between the recess and the area forms a constriction which is as flexible as possible. In this embodiment, a material is preferably used for the base body which allows flexible deformation.

According to an alternative or additional embodiment, it is provided that the clamping member is arranged in the recess such that the clamping member projects from the recess, and that the clamping member is in sealing contact with the heat exchanger. In this embodiment, the clamping member is partially outside the recess and thus comes in sealing contact with the heat exchanger. In one embodiment, the clamping member has a kind of sealing lip for the sealing function.

In one embodiment, two recesses in the base body and two associated clamping members are provided. The recesses and the associated clamping members are preferably associated with a common end plate of the heat exchanger.

One embodiment of the air conditioning system provides that the base body has two recesses and that the two recesses are arranged symmetrically relative to the heat exchanger. The recesses are for example arranged at one level along the longitudinal axis of the heat exchanger and have substantially the same distance from the longitudinal axis.

One embodiment of the air conditioning system consists in that the base body has a protuberance in the direction of the heat exchanger, and that the base body is in contact with the heat exchanger at least with the protuberance. In this embodiment, the base body has a kind of elevation which is directed in the direction of the heat exchanger due to its geometry and arrangement and comes into sealing contact with the heat body.

One embodiment of the air conditioning system provides that the recess extends parallel to an area in which the base body and/or the clamping member are/is in contact with the heat exchanger. In this embodiment, the recess is guided parallel to the contact surface of the base body or the clamping member on the heat exchanger. The sealing is thus achieved over the entire contact area. In one embodiment, the recess is a perpendicular bore or a vertically extending hole.

One embodiment of the air conditioning system provides that the clamping member is designed as a circular-cylindrical rod. The shape of the clamping member simplifies the manufacture thereof and reduces the effort when mounting the air conditioning system. In this embodiment, the oversize is preferably achieved in that the base area of the clamping member is greater than the base area of the recess.

One alternative embodiment of the air conditioning system provides that the clamping member is designed as a cylindrical rod having an oval base area. In one embodiment, the oversize in the oval base area is generated in that the base area of the clamping member is larger than the inner surface of the recess in at least one direction. Alternatively or additionally, the clamping member is rotated relative to the recess. In one embodiment, the recess thus for example also has an oval base area with the same dimensions as the clamping member. The oversize is generated by a rotation relative to each other.

One embodiment of the air conditioning system consists in that the recess has a circular cylindrical shape. In this configuration, the recess thus has a cylindrical shape with a circular-cylindrical base area.

One alternative embodiment of the air conditioning system provides that the recess is designed to be cylindrical with an oval base area.

In one embodiment, if the recess is designed to be cylindrical, the longitudinal axis of the cylinder extends parallel to the contact surface of the heat exchanger and the base body.

According to one embodiment, the recess has a lateral opening. The lateral opening for example allows the clamping member to project beyond the recess—in particular laterally. The lateral opening in particular extends up to the edge of the base body. In one embodiment, the opening is a longitudinal slot which extends over the entire length of the recess.

One embodiment of the air conditioning system consists in that the heat exchanger has at least one front-side end plate, and that the base body and/or the clamping member rest(s) in an area around the front-side end plate. If the base body and/or the clamping member are/is in contact with the end plate, the sealing results in a separation of the area around the front side of the heat exchanger from the interior area of the heat exchanger between the two end plates.

In one embodiment, the base body has a plurality of recesses and associated clamping members, the recesses being located in the areas of the end plates. In one embodiment, four recesses are present which are located on the four longitudinal sides of the two end plates.

One embodiment of the air conditioning system provides that the base body is an integral part of the housing. In this embodiment, the housing is for example made of a foamed plastic material (for example EPP), into which the components of the air conditioning system are inserted. The base body belongs to this housing which is dimensioned to fit the holding device. One embodiment consists in that the housing is made of a foamed plastic material at least in the area of the support. A foamed plastic material is for example EPP which is expanded polypropylene.

In an alternative embodiment, the base body is a separate unit which is arranged and fixed in the housing.

The object is furthermore achieved by the invention by a method of manufacturing an air conditioning system, wherein a heat exchanger is inserted into a base body of a holding device, and wherein at least one clamping member is inserted into at least one recess of the base body such that the base body and/or the clamping member come(s) into sealing contact with the heat exchanger.

According to the invention, the sealing of the heat exchanger is created when the air conditioning system is manufactured. First, the heat exchanger is inserted into a base body of a holding device. In one embodiment, the base body may be an integral part of the housing of the air conditioning. In the next step, a clamping member is inserted into the recess, as a result of which the base body and/or the clamping member come(s) into contact with the heat exchanger.

The aforementioned and following embodiments of the air conditioning system also apply accordingly to the method and vice versa. They are therefore not repeated.

One embodiment of the method provides that the clamping member is rotated during the insertion of the clamping member into the recess. In this embodiment, the clamping member is inserted and then rotated or is inserted into the recess with a rotating movement. This embodiment relates in particular to the embodiment of the air conditioning system in which there are two different orientations between the recess and the clamping member, one orientation causing the base body and/or the clamping member to be in sealing contact with the heat exchanger.

### BRIEF DESCRIPTION OF THE DRAWINGS

More specifically, there are numerous possibilities for designing and further developing the air conditioning system and the method according to the invention. To this end, reference is made, on the one hand, to the claims subordinated to the independent claims and, on the other hand, to the following description of example embodiments in conjunction with the drawing, in which:

FIG. 1 shows a schematic principle representation of an air conditioning system,

FIG. 2 a) and b) show a spatial representation of an air conditioning system according to a first embodiment and an enlarged detail thereof,

FIG. 3 a) and b) show a spatial representation of a detail of a second embodiment of the air conditioning system and a cropped view of the detail,

FIG. 4 shows a spatial representation of a detail of a third embodiment of the air conditioning system, and

FIG. 5 shows a spatial representation of a detail of a fourth embodiment of the air conditioning system.

### DETAILED DESCRIPTION

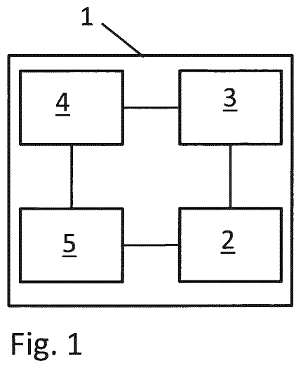

FIG. 1 schematically shows the structure of an air conditioning system for cooling a space. The air conditioning system is for example mounted on the roof of a caravan or a mobile home. The realized cooling circuit or cooling process is described in WO 2007/042065 A1, for example. The components involved are located in a housing 1 used for the positioning on the roof. In the cooling circuit, a compressor (alternatively referred to as supercharger) 2 compresses a gaseous refrigerant which is heated and transported to a condenser (alternatively referred to as liquefier) 3 via a refrigerant line. In the condenser 3, the heat of the refrigerant is transferred-via a heat exchanger-to the ambient air (or external air) from the environment around the room. The liquid refrigerant which is still under high pressure is expanded to a lower pressure in an expansion means 4 which is configured as a throttle, for example, as a result of which it cools down. In the evaporator 5, the air is cooled down via a further heat exchanger by transferring its thermal energy to the refrigerant. The refrigerant thus changes into the gaseous state. The gaseous refrigerant finally flows back to the compressor 2, so that the cooling circuit can be continued. The circuit can also be reversed so that the device serves as a room heater. In this case, the condenser 3 described above acts as an evaporator, and conversely, the evaporator 5 acts as a condenser.

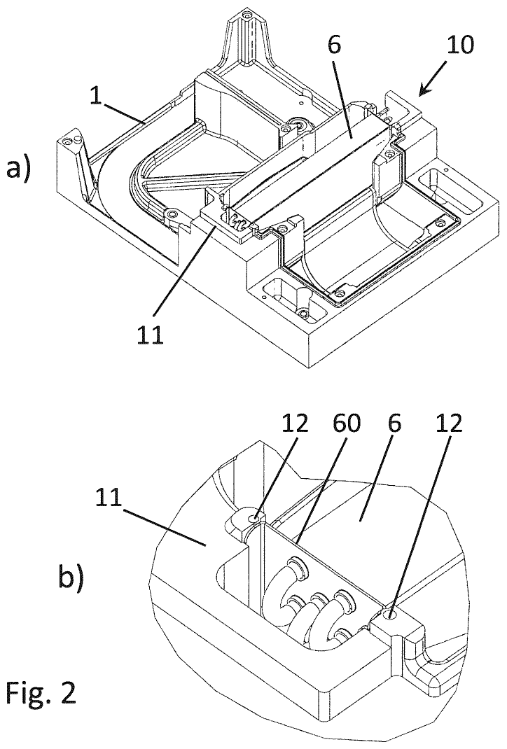

FIG. 2a) and b) represent part of the air conditioning system with the housing 1 and the heat exchanger 6. The other components are omitted for clarity. The heat exchanger 6 serves to cool the interior air which is guided through the housing 1. The heat exchanger 6 is held by a holding device 10, the base body 11 of which is here an integral part of the housing 1. The housing 1 is made of EPP.

The enlargement in FIG. 2b) shows the area in which the holding device 10 seals the front side of the heat exchanger 6 with respect to the inner area of the heat exchanger 6. To this end, the base body 11 in this embodiment is in sealing contact on both sides with the end plate 60 of the heat exchanger 6. The two recesses 12 can be seen, which are here configured as holes in the base body 11 and are located symmetrically at the level of the end plate 60.

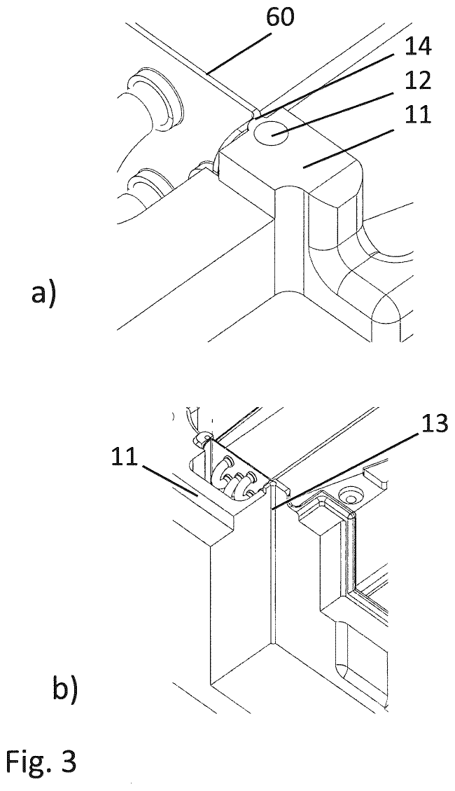

FIG. 3a) and b) show an alternative embodiment in which a protuberance 14 is located on the base body 11 at the level of the end plate 60 or more precisely at the level of the laterally angled longitudinal side of the end plate 60. The recess 12 has a cylindrical shape with a circular base area.

If a rod-shaped clamping member 13 having a base area which is larger than that of the recess 12 is inserted—as shown in FIG. 3b)—the material of the base body 11 is displaced in the direction of the end plate 60. As the dimensions and distances are matched to each other, the base body 12 comes into sealing contact with the end plate 60 via the protuberance 14.

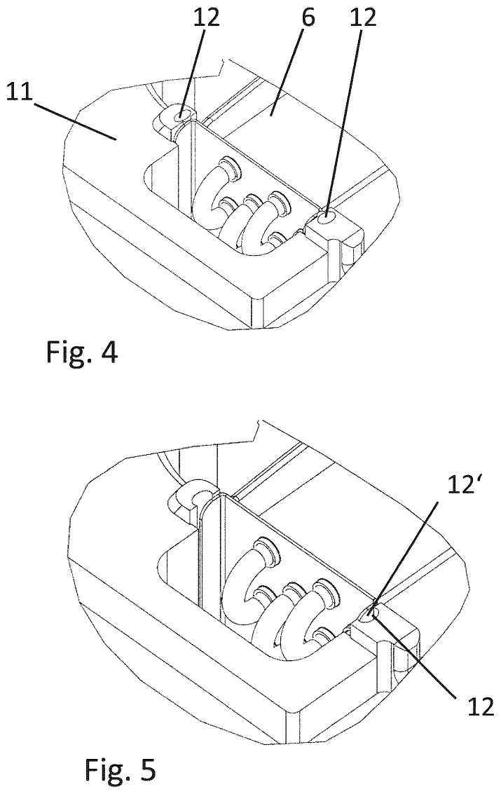

FIG. 4 shows recesses 12 which are also cylindrical and have an oval base area. If a clamping member having an identical or a slightly smaller base area is inserted into these recesses 12, there are at least two orientations between the recess 12 and the clamping member: in one case, there is no oversize so that the base body 11 is not deformed and is not in contact with the heat exchanger 6. In this case, it is for example possible to remove the heat exchanger 6. However, if the clamping member is rotated about its longitudinal axis relative to the recess 12, the material of the base body 11 is displaced and comes into sealing contact with the heat exchanger 6. The sealing can thus simply be removed and restored.

In FIG. 5, the recess 12 has a lateral opening 12′ through which the appropriate clamping member can project and be in contact with the end plate 60.

1-7. (canceled)

8. An air conditioning system, comprising:
a housing;
at least one heat exchanger; and
a holding device fixing the heat exchanger in the housing,
wherein the holding device has a base body having at least one recess and at least one clamping member,
wherein the holding device and the heat exchanger are configured and arranged relative to each other such that the base body and/or the clamping member are/is indirectly or directly in sealing contact with the heat exchanger.

9. The air conditioning system of claim 8, wherein in a relative orientation between the clamping member and the recess, the base body is deformed such that the deformed base body is in sealing contact with the heat exchanger.

10. The air conditioning system of claim 8, wherein the base body has a protuberance in a direction of the heat exchanger, and wherein the base body is in contact with the heat exchanger at least with the protuberance.

11. The air conditioning system of claim 8, wherein the base body has two recesses, and wherein the two recesses are arranged symmetrically relative to the heat exchanger.

12. The air conditioning system of claim 8, wherein the recess has a lateral opening.

13. A method of manufacturing an air conditioning system, the method comprising:
inserting a heat exchanger into a base body of a holding device; and
inserting at least one clamping member into at least one recess of the base body such that the base body and/or the clamping member come/comes into sealing contact with the heat exchanger.

14. The method of claim 13, wherein the clamping member is rotated during insertion of the clamping member.
